(19) United States
(12) Patent Application Publication
(10) Pub. No.: US 2014/0071709 A1
(43) Pub. Date: Mar. 13, 2014

(54) Light Guide Plate and Backlight Module

(71) Applicants: Jie Ren, Shenzhen (CN); Po-iem Lin, Shenzhen (CN)

(72) Inventors: Jie Ren, Shenzhen (CN); Po-iem Lin, Shenzhen (CN)

(73) Assignee: Shenzhen China Star Optoelectronics Technology Co. Ltd., Guangdong (CN)

(21) Appl. No.: 13/145,009

(22) PCT Filed: May 31, 2011
(86) PCT No.: PCT/CN2011/074981

§ 371 Date: Jul. 18, 2011

(30) Foreign Application Priority Data
May 19, 2011 (CN) 201120162869.8

(51) Int. Cl. F21V 8/00

(52) U.S. Cl. CPC G02B 6/0011
USPC 362/611; 362/627

(57) ABSTRACT

The present invention provides a light guide plate (LGP) and a backlight module. The backlight module has a light source and a LGP. The light source generates light. The LGP has a light input side surface receiving light generated by the light source; a reflective surface reflecting the light received by the light input side surface, so as to generate a planar light; a light output surface emitting the planar light; and a light compensation side surface opposite to the light input side surface and reflecting the light from the light input side surface and the reflective surface. The light compensation side surface is provided with fluorescence powders which are excited by the light to generate compensation light, so as to adjust color of the planar light emitted from the light output surface. The LGP of the present invention is provided with the light compensation side surface which is coated with the fluorescence powders to lower the color difference in surfaces of the LGP of the unilateral side-light type backlight module, so as to carry out better visual quality and product quality.

### FIELD OF THE INVENTION

The present invention relates to a light guide plate and a backlight module, and more particularly to a light guide plate and a backlight module capable of reducing the chromatic aberration of unilateral light input.

### BACKGROUND OF THE INVENTION

Nowadays, in a side-light type backlight module, light emitting diodes (LEDs) or cold cathode fluorescent lamps (CCFLs) are used to provide light sources. With the development of designs and compactness, large-scale backlight modules are gradually designed to use unilateral light input. With the enhancement of luminous efficiency of light sources, the design of unilateral light input will become a trend of designs, but there will be some problems accompanied with the designs.

As shown in FIG. 1, a schematic view of the structure of a traditional light guide plate (LGP), wherein the LGP 100 comprises a light input side surface 101, a reflective surface 102, a light output surface 103 and a reflective side surface 104. A light source 110 in FIG. 1 emits light which enters the LGP 100 through the light input side surface 101, and then the total reflection of the light is destroyed by optical microstructures 105 on the reflective surface 102, so that the light is emitted outward from the light output surface 103. However, once the light is transmitted in the LGP 100, emitted and scattered from the optical microstructures 105, energy of a portion of the light with some wavelengths (especially blue light) will be absorbed one time. As a result, once the light is scattered, the spectrum of the light will be varied. Thus, when the light is transmitted from one side of the LGP 100 to the other side thereof, the color of the light will gradually vary due to lacking a portion of the light with some wavelengths.

In a traditional side-light type backlight module, the optical microstructures 105 of the LGP 100 can be formed by printing or non-printing, wherein inks of the printed optical microstructures 105 mainly absorb the short wavelength light (such as blue light) emitted by the light source 110. Thus, when the light is transmitted to the reflective side surface 104 away from the light input side surface 101, the chromaticity of the color of the light will be varied (i.e. the color shifts toward yellow color), and the phenomenon of chromatic aberration will occur in the surfaces (i.e. each point in the surfaces of the backlight module has uneven color). If the size of the LGP 100 is larger, the chromatic aberration is more serious, resulting in seriously affecting visual quality and product quality.

On the other hand, the non-printed type LGP uses material of methylmethacrylate styrene (MS) copolymer or other material, and has optical microstructures. Because the MS material or other material essentially absorbs short wavelength light, the phenomenon of chromatic aberration in the surfaces of the LGP will still occur.

As a result, it is necessary to provide a light guide plate and a backlight module to solve the problems existing in the conventional technologies, as described above.

### SUMMARY OF THE INVENTION

The present invention provides a light guide plate and a backlight module, which are used to solve the problems of uneven color of each point in surfaces of a light guide plate of a backlight module of the traditional flat panel display.

A primary object of the present invention is to provide a light guide plate (LGP), wherein the LGP comprises a light input side surface receiving light; a reflective surface reflecting the light received by the light input side surface and generating a planar light; a light output surface emitting the planar light; and a light compensation side surface opposite to the light input side surface and reflecting the light from the light input side surface and the reflective surface; wherein the light compensation side surface is provided with fluorescence powders which are excited by the light to generate compensation light, so as to adjust color of the planar light emitted from the light output surface; wherein the fluorescence powders are doped in a body of the light compensation side surface, and the light compensation side surface is formed with at least one ridge.

The present invention further provides a light guide plate (LGP), wherein the LGP comprises a light input side surface receiving light; a reflective surface reflecting the light received by the light input side surface and generating a planar light; a light output surface emitting the planar light; and a light compensation side surface opposite to the light input side surface and reflecting the light from the light input side surface and the reflective surface; wherein the light compensation side surface is provided with fluorescence powders which are excited by the light to generate compensation light, so as to adjust color of the planar light emitted from the light output surface.

Another object of the present invention is to provide a backlight module, wherein the backlight module comprises:

a light source generating light; and

a light guide plate (LGP) including:
a light input side surface receiving light generated by the light source;
a reflective surface reflecting the light received by the light input side surface, and destroying total reflection of the light received by the light input side surface in the LGP to thus generate a planar light;
a light output surface emitting the planar light; and
a light compensation side surface opposite to the light input side surface and reflecting the light from the light input side surface and the reflective surface; wherein the light compensation side surface is provided with fluorescence powders which are excited by the light to generate compensation light, so as to adjust color of the planar light emitted from the light output surface.

In one embodiment of the present invention, the fluorescence powders are doped in a body of the light compensation side surface.

In one embodiment of the present invention, the light compensation side surface is attached with a transparent film coated with the fluorescence powders thereon.

In one embodiment of the present invention, the light compensation side surface is attached with a transparent film doped with the fluorescence powders therein.

In one embodiment of the present invention, the fluorescence powders include blue fluorescence powders.

In one embodiment of the present invention, the light compensation side surface is formed with at least one ridge.

In one embodiment of the present invention, the LGP is a LGP made of methylmethacrylate styrene (MS) copolymer and having optical microstructures.

In one embodiment of the present invention, one side of the light output surface is provided with a brightness enhancement film to enhance the light extraction efficiency.

In one embodiment of the present invention, one side of the reflective surface is provided with a reflective unit to enhance the reflection efficiency.

In comparison with the traditional LGP and backlight module which have the design of unilateral light input with the problem of backlight chromatic aberration, the LGP and backlight module of the present invention is provided with the light compensation side surface which is coated with the fluorescence powders to lower the color difference in surfaces of the LGP of the unilateral side-light type backlight module, so as to carry out better visual quality and product quality.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a schematic view of the structure of a traditional light guide plate (LGP);

FIG. 2 is a schematic view of the structure of a light guide plate according to a first preferred embodiment of the present invention; and

FIG. 3 is a schematic view of the structure of a light guide plate according to a second preferred embodiment of the present invention.

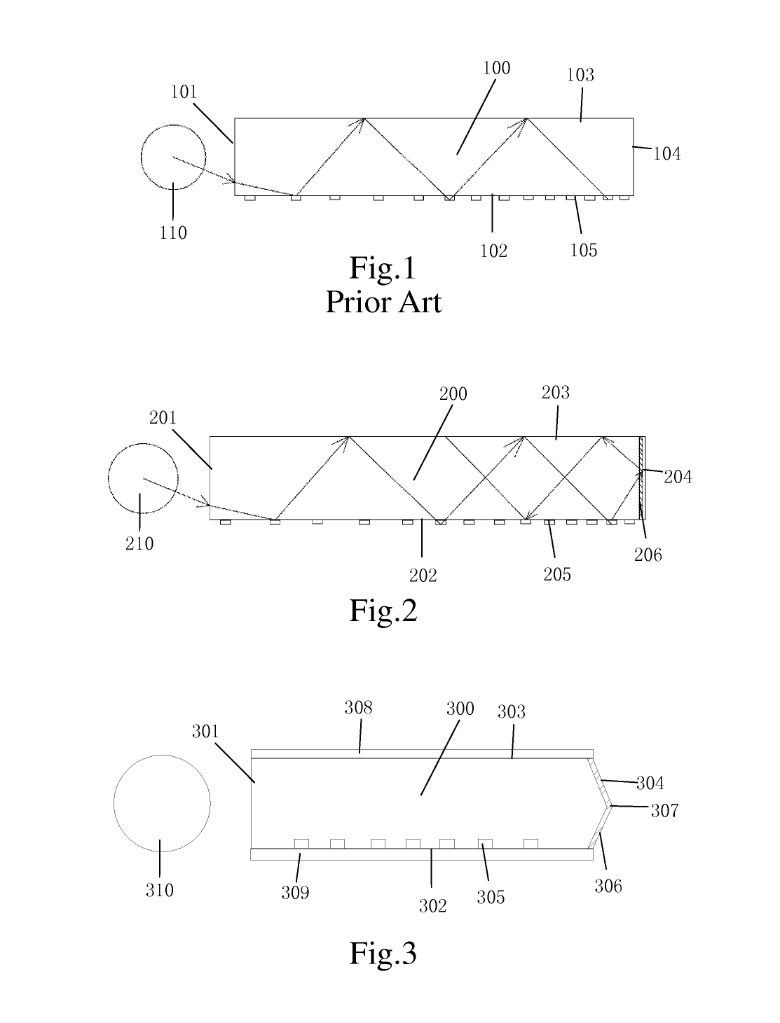

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, and etc., are only directions by referring to the accompanying drawings, and thus the used directional terms are used to describe and understand the present invention, but the present invention is not limited thereto.

Referring now to FIG. 2, a schematic view of the structure of a light guide plate (LGP) according to a first preferred embodiment of the present invention is illustrated. The backlight module of the present invention is a side-light type backlight module, wherein the backlight module comprises a LGP 200 and a light source 210. For example, the light source 210 is can be cold cathode fluorescent lamp (CCFL), light emitting diode (LED), organic light emitting diode (OLED), electro-luminescence (EL), light bar or any combination thereof. The LGP 200 comprises a light input side surface 201, a reflective surface 202, a light output surface 203 and a light compensation side surface 204, wherein the light input side surface 201 is used to receive light; the reflective surface 202 is used to reflect the light received by the light input side surface 201, and destroy total reflection of the light received by the light input side surface 201 in the LGP 200 to thus generate a planar light; the light output surface 203 is used to emit the planar light outward; the light compensation side surface 204 is formed on one side of the LGP 200 away from the light input side surface 201, i.e. opposite to the light input side surface 201. The light compensation side surface 204 is used to reflect the light from the light input side surface 201 and the reflective surface 202, wherein the light compensation side surface 204 is provided with fluorescence powders 206, and the fluorescence powders 206 can be excited by the light to generate compensation light, so as to adjust color of the planar light emitted from the light output surface 203.

The LGP and the backlight module of the present invention are used to solve the problem of backlight chromatic aberration due to unilateral light input of the traditional LGP and backlight module. In the schematic view of the structure of the LGP according to the first preferred embodiment of the present invention, the light compensation side surface 204 of the LGP 200 is coated with a layer of the fluorescence powders 206, wherein the fluorescence powders 206 is mainly fluorescence powders capable of being excited to generate short wavelength light. Thus, when the transmitted light is emitted to the fluorescence powders 206, the fluorescence powders 206 will be excited to generate a greater amount of short wavelength compensation light which is then reflected back to compensate the portion of short wavelength light (such as blue light) absorbed by inks of optical microstructures 205, so that the light relatively spaced away from the light source 210 and emitted outward the LGP 200 can be compensated by the foregoing color compensation.

As the preferred embodiment of the present invention, the fluorescence powders 206 can be doped in a body (substrate) of the light compensation side surface 204, i.e. the fluorescence powders 206 are mixed into plastic or other material for fabricating the body of the light compensation side surface 204 according to a predetermined ratio, and can be dispersed in the body of the light compensation side surface 204 by injection molding method using molds. Alternatively, the surface of the light compensation side surface 204 can be attached with a transparent film, and the transparent film is coated with the fluorescence powders 206 thereon or the transparent film is doped with the fluorescence powders 206 therein. The coating method can be steps of: mixing the fluorescence powders 206 into a chemical solvent; and then applying the chemical solvent onto the surface of the light compensation side surface 204 or directly applying the fluorescence powders 206 onto the transparent film. The method of doping the fluorescence powders 206 into the transparent film can be steps of: mixing the fluorescence powders 206 with a transparent material; melting the mixture; and then cooling to form the doped transparent film. A user can select a suitable method to provide the fluorescence powders 206 on the light compensation side surface 204 according to needs.

As the preferred embodiment of the present invention, because the inks of the optical microstructures 205 mainly absorb short wavelength light emitted from the light source 210, the used fluorescence powders 206 can include blue fluorescence powders. Thus, when the light is transmitted to the blue fluorescence powders, the blue fluorescence powders will be excited to generate a greater amount of short wavelength compensation light which is then reflected back to compensate the portion of short wavelength light absorbed by the inks of the optical microstructures 205, so that the light relatively spaced away from the light source 210 and emitted outward the LGP 200 can be compensated by the foregoing color compensation. Meanwhile, the fluorescence powders 206 of the light compensation side surface 204 can be adjusted to different ratio according to different size of the LGP 200. When the size of the LGP 200 of unilateral light input is larger, the amount of the blue fluorescence powders must be increased to compensate a greater amount of short wavelength light; otherwise, when the size of the LGP 200 is larger and the light is transmitted far away from the light source 210, the chromatic aberration in surfaces of the LGP 200 is more seriously.

As described above, only if the light compensation side surface 204 is provided with the fluorescence powders 206 to lower the color difference in surfaces of the LGP 200 of the unilateral side-light type backlight module, any arrangement of providing the fluorescence powders 206 on the light compensation side surface 204 is all within the scope of the present invention.

Referring to FIG. 3, a schematic view of the structure of a light guide plate (LGP) according to a second preferred embodiment of the present invention is illustrated, wherein the LGP 300 comprises a light input side surface 301, a reflective surface 302, a light output surface 303 and a light compensation side surface 304, wherein the light input side surface 301 is used to receive light; the reflective surface 302 is used to reflect the light received by the light input side surface 301, and destroy total reflection of the light received by the light input side surface 301 in the LGP 300 to thus generate a planar light; the light output surface 303 is used to emit the planar light outward; the light compensation side surface 304 is formed on one side of the LGP 300 away from the light input side surface 301, i.e. opposite to the light input side surface 301. The light compensation side surface 304 is used to reflect the light from the light input side surface 301 and the reflective surface 302, wherein the light compensation side surface 304 is provided with fluorescence powders 306 which can be excited by the light to generate compensation light, so as to adjust color of the planar light emitted from the light output surface 303.

Meanwhile, the light compensation side surface 304 is formed with at least one ridge 307 extended outward. Based on the principle of reflection, when the included angle of the ridge 307 is smaller, the deflection angle of the light is larger; and when the included angle of the ridge 307 is larger, the deflection angle of the light is smaller. According to the light input side surface 301, the reflective surface 302, the light output surface 303 and the ridge design of the light compensation side surface 304 (especially the ridge 307 on the light compensation side surface 304), the light extraction angle of the LGP 200 can be adjusted, so as to increase the light extraction efficiency of the LGP 200. The number, shape and other designs of the ridge 307 can be adjusted according to the light extraction efficiency or other factors, and the present invention is not limited thereto. Only if the light compensation side surface 304 provided with fluorescence powders 306 can be used to lower the color difference in surfaces of the LGP 300 of the unilateral side-light type backlight module, any arrangement thereof is all within the scope of the present invention.

Furthermore, one side of the light output surface 303 can be provided with a brightness enhancement film 308 to enhance the light extraction efficiency; and one side of the reflective surface 302 is provided with a reflective unit 309 to enhance the reflection efficiency. As shown in FIG. 3, the reflective unit 309 is used to reflect the light emitted downward out of the LGP 300 back to the LGP 300, so as to increase the utilization of the light. The brightness enhancement film 308 provided on one side of the light output surface 303 of the LGP 300 can increase the light extraction efficiency of the LGP 300.

In the second embodiment of the present invention, the fluorescence powders 306 can be doped in a body (substrate) of the light compensation side surface 304, i.e. the fluorescence powders 306 are mixed into plastic or other material for fabricating the body of the light compensation side surface 304 according to a predetermined ratio, and can be dispersed in the body of the light compensation side surface 304 by injection molding method using molds. Alternatively, the surface of the light compensation side surface 304 can be attached with a transparent film, and the transparent film is coated with the fluorescence powders 306 thereon or the transparent film is doped with the fluorescence powders 306 therein. The coating method can be steps of: mixing the fluorescence powders 306 into a chemical solvent; and then applying the chemical solvent onto the surface of the light compensation side surface 304 or directly applying the fluorescence powders 306 onto the transparent film. The method of doping the fluorescence powders 306 into the transparent film can be steps of: mixing the fluorescence powders 306 with a transparent material; melting the mixture thereof; and then cooling to form the doped transparent film. A user can select a suitable method to provide the fluorescence powders 306 on the light compensation side surface 304 according to needs.

As the preferred embodiment of the present invention, the LGP can be a LGP made of methylmethacrylate styrene (MS) copolymer and having optical microstructures. The LGP of the present invention also can be other non-printed type LGP made of other material, including MS LGP having optical microstructures and etc., wherein the main factor of the chromatic aberration in the MS LGP is that the MS material absorbs the short wavelength light (such as blue light). Thus, the LGP structure of the present invention can be applied to the non-printed type LGP to solve the chromatic aberration in the surfaces of the LGP, in order to improve the visual quality and product quality.

Moreover, the present invention is further related to a backlight module, wherein the backlight module comprises: a light source and a light guide plate (LGP). The light source generates light. The LGP includes: a light input side surface receiving light generated by the light source; a reflective surface reflecting the light received by the light input side surface, and destroying total reflection of the light received by the light input side surface in the LGP to thus generate a planar light; a light output surface emitting the planar light; and a light compensation side surface opposite to the light input side surface and reflecting the light from the light input side surface and the reflective surface; wherein the light compensation side surface is provided with fluorescence powders which are excited by the light to generate compensation light, so as to adjust color of the planar light emitted from the light output surface.

The present invention has been described with a preferred embodiment thereof and it is understood that many changes and modifications to the described embodiment can be carried out without departing from the scope and the spirit of the invention that is intended to be limited only by the appended claims.

1. A light guide plate, comprising:
a light input side surface receiving light;
a reflective surface reflecting the light received by the light input side surface and generating a planar light;
a light output surface emitting the planar light; and
a light compensation side surface opposite to the light input side surface and reflecting the light from the light input side surface and the reflective surface;
characterized in that:
the light compensation side surface is provided with fluorescence powders which are excited by the light to generate compensation light, so as to adjust color of the planar light emitted from the light output surface;
wherein the fluorescence powders are doped in a body of the light compensation side surface; and
the light compensation side surface is formed with at least one ridge.

2. A light guide plate, comprising:
a light input side surface receiving light;
a reflective surface reflecting the light received by the light input side surface and generating a planar light;
a light output surface emitting the planar light; and
a light compensation side surface opposite to the light input side surface and reflecting the light from the light input side surface and the reflective surface;
characterized in that:
the light compensation side surface is provided with fluorescence powders which are excited by the light to generate compensation light, so as to adjust color of the planar light emitted from the light output surface.

3. The light guide plate according to claim 2, characterized in that: the fluorescence powders are doped in a body of the light compensation side surface.

4. The light guide plate according to claim 2, characterized in that: the light compensation side surface is attached with a transparent film coated with the fluorescence powders thereon.

5. The light guide plate according to claim 2, characterized in that: the light compensation side surface is attached with a transparent film doped with the fluorescence powders therein.

6. The light guide plate according to claim 2, characterized in that: the fluorescence powders include blue fluorescence powders.

7. The light guide plate according to claim 2, characterized in that: the light compensation side surface is formed with at least one ridge.

8. The light guide plate according to claim 2, characterized in that: the light guide plate is a light guide plate made of methylmethacrylate styrene copolymer and having optical microstructures.

9. The light guide plate according to claim 2, characterized in that: one side of the light output surface is provided with a brightness enhancement film to enhance the light extraction efficiency.

10. The light guide plate according to claim 2, characterized in that: one side of the reflective surface is provided with a reflective unit to enhance the reflection efficiency.

11. A backlight module, comprising:
a light source generating light; and
a light guide plate including:
a light input side surface receiving light generated by the light source;
a reflective surface reflecting the light received by the light input side surface and generating a planar light;
a light output surface emitting the planar light; and
a light compensation side surface opposite to the light input side surface and reflecting the light from the light input side surface and the reflective surface;
characterized in that:
the light compensation side surface is provided with fluorescence powders which are excited by the light to generate compensation light, so as to adjust color of the planar light emitted from the light output surface.

12. The backlight module according to claim 11, characterized in that: the fluorescence powders are doped in a body of the light compensation side surface.

13. The backlight module according to claim 11, characterized in that: the light compensation side surface is attached with a transparent film coated with the fluorescence powders thereon.

14. The backlight module according to claim 11, characterized in that: the light compensation side surface is attached with a transparent film doped with the fluorescence powders therein.

15. The light guide plate according to claim 11, characterized in that: the light compensation side surface is formed with at least one ridge.
